(19) United States
(12) Patent Application Publication
(10) Pub. No.: US 2003/0179755 A1
(43) Pub. Date: Sep. 25, 2003

(54) System and method for handling prioritized data in a network

(76) Inventor: Alexander Gibson Fraser, Bernardsville, NJ (US)

Correspondence Address: Samuel H. Dworetsky, AT&T CORP., P.O. Box 4110, Middletown, NJ, 07748-4110, US

(21) Appl. No.: 10/053,023

(22) Filed: Jan. 18, 2002

(51) Int. Cl. H04L 12/28

(52) U.S. Cl. 370/395.42; 370/395.4

(57) ABSTRACT

A system and method for reducing the delay of high-priority data in a packet network. A packet is comprised of subpackets. The transmission of subpackets of a first packet having a first priority is suspended in order to send the subpackets of a second packet having a higher priority. When the subpackets of the higher priority second packet have been sent, the transmission of the subpackets of the lower priority first packet is resumed.

### TECHNICAL FIELD

The invention relates to data networks in general, and in particular to reducing the delay in sending certain higher priority data over lower priority data in a packet network.

### BACKGROUND OF THE INVENTION

Certain data networks employ connectionless or connection-oriented switching to carry digital traffic from a source to its intended destination. A communication from a source to its intended destination is called an “end-to-end” communication, and a connection over which the data flows from the source to the intended destination is called an “end-to-end connection.”

Data (such as a message) in a connectionless network are broken into packets called “datagrams.” Each datagram includes a label (a “header”) designating its source and final destination address and is treated as an independent entity by the network. No end-to-end connection per se is created by the network to carry a datagram from its source to its intended destination. Rather, when a datagram is received by a connectionless switch (also known as a “datagram router”), the switch uses the destination address of the datagram and network conditions to decide which next entity (i.e., another switch or the datagram's intended destination) to which to forward the datagram. The datagrams of a single message can therefore follow different paths through the network from their source to their final destination, where they are reassembled into the original message from which they were derived.

It is possible to treat a sequence of datagrams that correspond to a single data stream (e.g., were derived from the same message or data stream) as though it belonged to a connection, at least between datagram routers, if not necessarily end-to-end. In Multi-Protocol Label Switching (MPLS) an additional header is added to each datagram between datagram routers to assure that datagrams with the same headers (i.e., headers with the same source and final destination addresses) follow the same path between datagram routers. See Requirements for Traffic Engineering Over MPLS, RFC 2702, September 1999 <http://www.ietf.org/rfc/rfc2702.txt>. An example of a packet switched network protocol is the Internet Protocol (“IP”). See Internet Protocol, RFC 791, September 1981, <http://194.52.182.96/rfc/rfc791.html>.

In a connection-oriented network (also known as a “virtual circuit network” or “cell-switched network”) a virtual connection is established when a path for the data through the network from the source to the final destination is determined and assigned a connection identifier. The data packets are broken into “cells,” each of which is labeled (in its header) with the identifier of the connection. When a virtual circuit switch receives a cell, it reads the cell's connection identifier, refers to a table that identifies the output port of the switch that corresponds to the connection identifier, and then sends the cell to the next switch (or final destination) through that port. At the last switch prior to their final destination, cells are reassembled to reconstitute the data packets sent from the source. An example of a connection-oriented network protocol is the Asynchronous Transfer Mode (ATM) protocol. See, e.g., Classical IP and ARP over ATM, RFC 1577, January 1994, <http://www.ietf.org/rfc/rfc1577.txt?number=1577>.

Some networks use both connectionless datagrams and connection-oriented cells to move data. The cells that comprise a datagram are sent over a predetermined connection from a first point to a second point in the network. At the second point, the datagram is reassembled from the cells, and then forwarded to another switch (or its final destination) in a connectionless fashion. The transmission facilities (e.g., wire, fiber optic cable, subnetwork, etc.) between network switches therefore typically carry cells from different data sources interleaved in a way that is not usually convenient for the datagram reassembly process.

Each network has a finite capacity to carry data. When a switch receives packets at a rate higher than that of its capacity to process them, it must store some of the packets in a buffer. There, the packets are queued for processing when the load on the switch decreases. Buffering packets introduces delay (“latency”) in the delivery of a message. The size of each buffer is also finite. If the buffer of a switch fills to capacity and the load on the switch remains high, the switch can lose (“drop”) incoming packets. In this case, either part or all of the message of which the dropped packets are a part must be retransmitted by the source (introducing delay), or the message may not be received by its intended destination at all.

Latency and loss are more tolerable for certain types of communication than for others. For example, an e-mail message can in many cases be delayed by a few minutes in transmission from sender to destination with no ill effect. On the other hand, packets carrying voice signals that are part of a live conversation are less tolerant of latency. Delay causes awkward gaps in the conversation, where one party does not know if the other is finished talking or not. Likewise, the experience of viewing an audio/video that is sent as a stream of packets is relatively intolerant of latency. Network delay can make the audio and/or the video portion start and stop intermittently, or cause the server to stop sending the stream before it is finished. It can therefore be advantageous to treat different types of traffic with different priorities. Those types that are more tolerant of latency can be treated with a lower priority, while those that are less tolerant can be treated with a higher priority.

FIG. 1 shows an ATM data network including transmission facilities, switches, and representative inputs to that network and the desired destinations. In this example, it is desired to connect Source 1 101 to Destination 1 131, Source 2 102 to Destination 2 132, and Source 3 103 to Destination 3 133. It should be realized that this example is given for illustrative purposes only, and that any real network would almost certainly contain many more switches, transmission facilities, inputs, and outputs.

Originating switches such as Switch 111 and Switch 112 segment each of their inputs into cells of 48 octets of 8 bits each and append a header of 5 octets to form cells of total length 53 octets. The header contains, among other information, addressing, priority level, and an indication if the cell is the last one in the message or packet from which the cell is derived. Virtual connections are set up upon request from a source specifying a destination. For example, Source 1 101 requests a virtual connection to Destination 1 131. Upon receiving this request, Switch 111 makes an entry in its routing table to route subsequent cells from Source 1 to Switch 113 over transmission facility 121. Switch 113 in turn will make a routing entry for this input to Switch 116 over facility 128. Finally, Switch 116 will remove headers from cells on this virtual connection and reassemble them for delivery to Destination 1 131. This virtual connection is created only if sufficient resources are available at each stage, and the connection remains active until an instruction is received to terminate it. All cells from a virtual connection follow the path of the connection while the connection exists. In a similar manner, virtual connections are set up and maintained between the other source-destination pairs. In addition to the paths to be followed for each virtual connection, a priority is also assigned to each virtual connection as part of the setup procedure.

A typical known cell switch for operation in an ATM network is the IDT77V400 Switchstar™ integrated switch memory and the IDT77V500 Switchstar™ integrated switch controller, manufactured by Integrated Device Technology, Inc. This switch can reassemble cells at switches other than the ones closest to the virtual connection destination. When this feature is enabled, cells are held in memory until the several cells of one packet can be output contiguously. This process is helpful when the recipient expects packets rather than individual cells. The cells of a packet are not interrupted until its output process is completed. Higher priority cells cannot preempt a lower priority packet, disadvantageously delaying the sending of the higher priority data.

### SUMMARY OF THE INVENTION

In accordance with an embodiment of the present invention, the transmission of a packet with a lower priority can advantageously be interrupted by the transmission of a higher priority data packet. After the higher priority data has been sent, transmission of the interrupted lower priority packet is resumed. An embodiment of the present invention is recursive, meaning that an interrupting packet can be itself interrupted by a yet higher priority transmission, and so on. The present invention thereby advantageously ensures that higher priority data is promptly sent without waiting for the completion of a lower priority packet transmission. As used herein, a first packet has a higher priority than a second packet if the urgency of sending the first packet is higher than the urgency of sending the second packet.

In accordance with an embodiment of the present invention, a data packet can be subdivided into cells. As used herein, a “packet” is any discrete portion of information that includes some addressing information and a payload. Examples of packets include an Internet Protocol packet, a circuit-switched packet, etc. Examples of addressing information include an Internet Protocol network destination address, an IP header, a circuit identifier, etc. A “payload” is data that is being moved in the packet through the network. Examples of payload information include the contents of an e-mail, software instructions, a digital audio signal, etc. As used herein, the term “cell” is a type of packet that, either alone or together with other cells, comprises a packet. Thus, a cell has addressing information and a payload. In accordance with an embodiment of the present invention, the transmission of cells belonging to a packet of low priority is interrupted to accommodate the transmission of cells of a packet of higher priority. In this way, the transmission of a lower priority packet advantageously does not delay the transmission of a higher priority packet.

Another advantage of the present invention is the reduction in the number of buffers required to reassemble packets from their constituent cells. A known cell switch can require an unlimited number of buffers for packet reassembly, whereas a switch in accordance with the present invention can require only a number of buffers equal to the number of different priority levels of packets recognized by the switch.

### BRIEF DESCRIPTION OF THE DRAWINGS

FIG. 1 shows a prior art switched data network.

FIG. 2 shows a block diagram of a switch in accordance with an embodiment of the present invention.

FIG. 3 shows a first configuration of cells of packet data being sent from a first switch to a second switch in accordance with an embodiment of the present invention.

FIG. 4 shows a second configuration of cells of packet data being sent from a first switch to a second switch in accordance with an embodiment of the present invention.

FIG. 5 shows a third configuration of cells of packet data being sent from a first switch to a second switch in accordance with an embodiment of the present invention.

FIG. 6 is a flowchart illustrating the method in accordance with an embodiment of the present invention.

### DETAILED DESCRIPTION

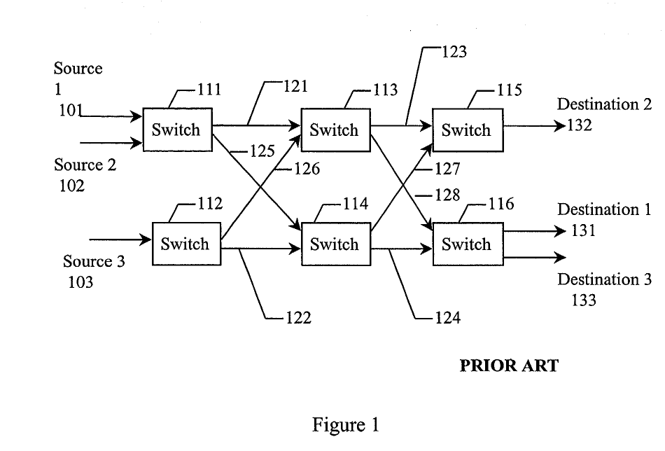

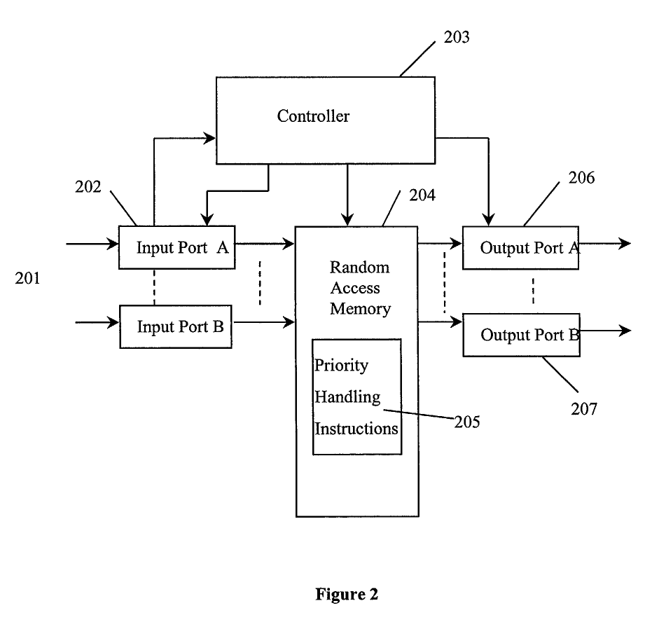

A block diagram of a switch in accordance with an embodiment of the present invention is shown in FIG. 2. The switch can occupy the place of, for example, switch 113 in the system shown in FIG. 1. A transmission facility 201 is coupled to an input port 202 that is coupled to controller 203. A packet arrives through transmission facility 201 at input port 202. Controller 203 examines the header of each incoming cell to determine what action to take. Controller 203 can be a general purpose microprocessor, such as the Intel Pentium III, manufactured by the Intel Corporation of Santa Clara, Calif. Controller 203 can also be an Application Specific Integrated Circuit (ASIC) that embodies at least part of the method in accordance with an embodiment of the present invention in hardware and/or firmware. Likewise, controller 203 can be a system of general purpose microprocessors and/or ASICs.

Controller 203 is coupled to memory 204. Memory 204 is any device adapted to store digital information, such as Random Access Memory (RAM), Read Only Memory (ROM), a hard disk, flask memory, optical memory, etc., or combination thereof. At least part of memory 204 should be writeable as well as readable. Memory 204 can also include one or more buffers (not shown) for storing received cells, and a routing table (not shown) mapping circuit identifiers to output ports. Memory 204 includes priority handling instructions 205 that are adapted to be executed by processor 203 to perform at least part of the method in accordance with an embodiment of the present invention. Memory 204 can be a component of a single device, or be distributed over several different devices, e.g., that are coupled to each other through a network.

If the cell received at input port 202 corresponds to an existing virtual connection, controller 203 examines the routing table to determine over which output port 206 or 207 to send that cell. The header of the cell is modified to denote the next path in the connection. Controller 203 decides the order in which cells are sent to an output port 206 and/or 207. For example, data from a plurality of sources can share a single transmission facility. Controller 203 determines how cells from these sources to various destinations are to be sent over the shared transmission facility, typically in a multiplexed fashion.

In accordance with an embodiment of the present invention, cells for a given virtual connection are stored to a buffer in memory 204 until an end-of-packet indicator is received, typically in the header of the cell that carries the last part of data sent over the connection. Alternatively, the cells are stored up until a predetermined number of stored cells are accumulated. Controller 203 then sends a contiguous block of accumulated cells to the appropriate output port, e.g., to output port 206. A block of cells is called a “cluster.” This simplifies the routing operation at subsequent switches.

Simply sending a cluster of accumulated cells that belong to a virtual connection can disadvantageously add delay the transmission of higher priority data. An embodiment of the present invention advantageously permits the transmission of a cluster of contiguous cells to be interrupted to transmit higher priority data. After the transmission of the higher priority data is completed, the transmission of the interrupted cluster is resumed. Cells of differing priority can be separated at the destination switch (the last switch at or before the final destination) and reassembled.

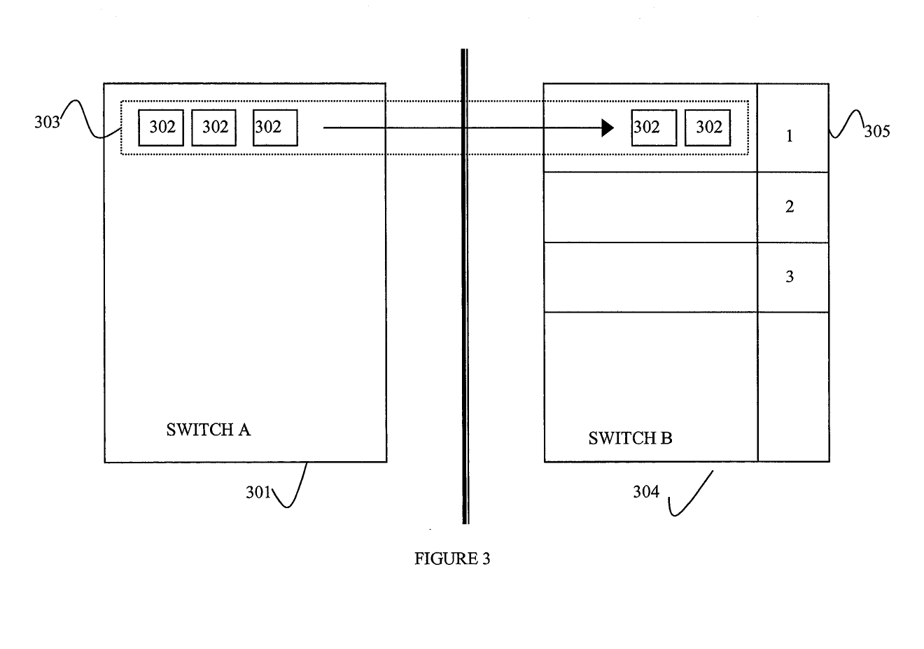

The method in accordance with an embodiment of the present invention is illustrated by FIG. 3. Switch A 301 is sending the cells 302 of priority level 1 packet 303 to switch B 304. Switch B 304 stores the cells 302 in its priority 1 buffer 305, which stores cells that comprise packets having a priority level of 1.

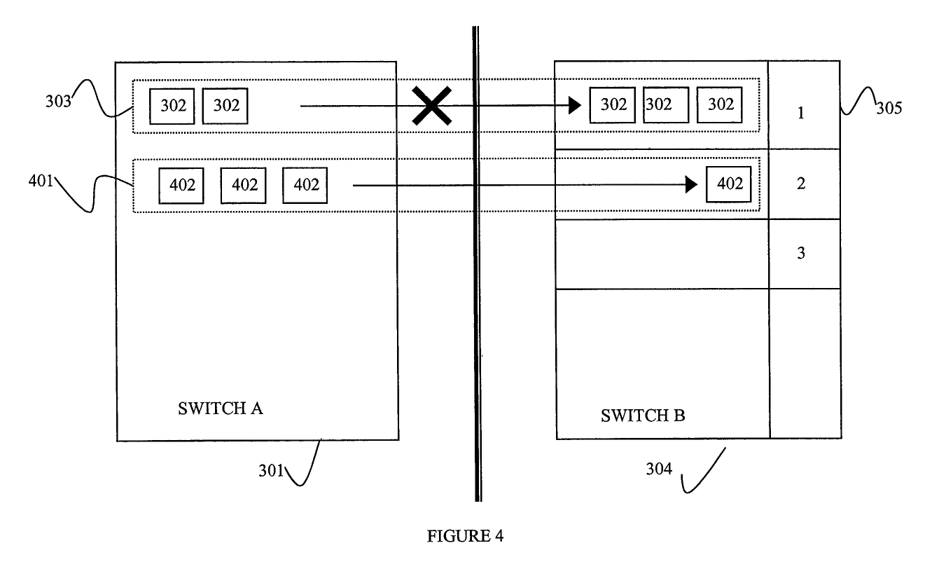

FIG. 4 shows the same switches A 301 and B 304 at a slightly later point in time than FIG. 3. While cells 302 are transmitted, switch A processes a packet 401 having a priority level 2, which is higher (more urgent) than priority level 1 and packet 303. Switch A recognizes that newly processed packet 401 has a higher priority level than packet 303, and suspends (halts, interrupts) the transmission of cells 302. Switch A 301 begins sending cells 402 of higher priority level 2 packet 401. Switch B 304 stores received cells 402 in priority 2 buffer 403. Priority 2 buffer 403 stores cells that comprise packets having a priority level of 2.

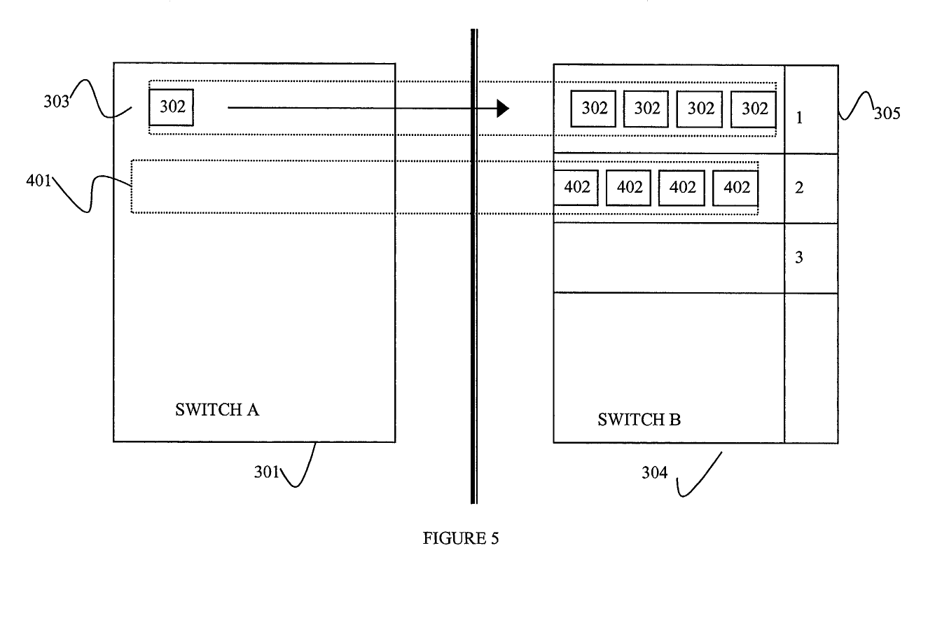

FIG. 5 shows the same switches A 301 and B 304 at a slightly later point in time than FIG. 4. Switch B 304 has just finished receiving all of the cells 402 of priority 2 packet 401, and switch A 301 resumes sending cells 302 of lower priority packet 303 to switch B 304. Had switch A 301 processed yet another packet with a higher priority level than either packets 303 and 401, switch A 303 would have interrupted the transmission of cells 402 of packet 401 to send the cells of the higher priority packet. When those cells had all been sent, the transmission of the unsent cells 402 of lower priority packet 401 would have been resumed. When all of cells 402 were sent, then the transmission of cells 302 of yet lower priority packet 303 would have been resumed.

The method in accordance with an embodiment of the present invention advantageously permits the transmission of cells of a higher priority packet through a given port on a switch, even when the cells of a lower priority packet are already being transmitted by the switch through the same port. A controller processes a packet Px and determines it has a priority level A. The packet is subdivided into cells, and the cells of packet Px are sent from the switch. Next, the controller processes packet Py, and determines that it has a priority level B. The controller determines if priority level B is higher than priority level A. If packet Py priority level B is less than or equal to packet Px priority level A, then the switch continues to send the cells of packet Px. If priority level B is higher than priority level A, then the switch suspends the transmission of the cells of packet Px, and sends the cells of higher priority packet Py. This process is repeated for each packet processed by the switch, so that the transmission of cells of lower priority packets is suspended so as not to delay the transmission of cells of higher priority packets. When all of the cells of the highest priority packet have been sent, the transmission of cells of the next lowest priority packet is resumed. When the cells of the next lowest priority packet have been sent, the transmission of the cells of a lower priority packet, if any, is resumed. This process can advantageously be performed by a switch for packets with a plurality of priority levels. In this way, the transmission of cells of a higher priority packet are not delayed by waiting for all of the cells of a lower priority packet to be transmitted.

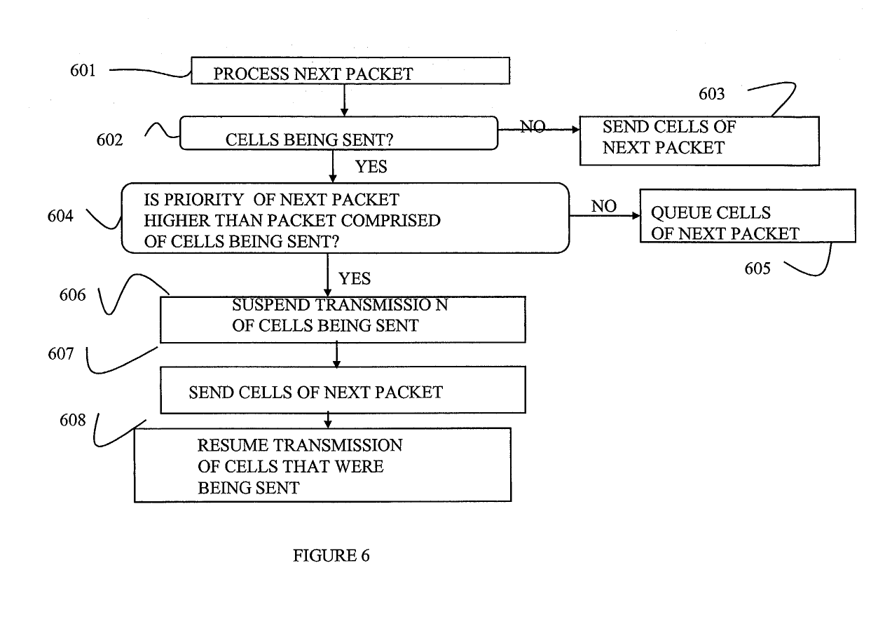

A flowchart illustrating the method in accordance with an embodiment of the present invention is shown in FIG. 6. A switch processes a new packet, step 601, which can include determining the port through which to send it, and subdividing it into cells. If the port is not presently in use, step 602, i.e., cells of another packet are not being sent through the port, then the cells of the new packet are sent through the port, step 603. If cells of another packet (the “other packet”) are already being sent through the port, step 602, then the switch determines if the priority of the new packet is higher than the priority of the other packet, step 604. If the priority of the new packet is less than or equal to the priority of the other packet, then the switch continues to send the cells of the other packet through the port, and the new packet is queued for transmission, step 605. If the priority of the new packet is higher than the priority of the other packet, step 604, then the transmission of the cells of the lower priority other packet are suspended, step 606, and the cells of the higher priority new packet are sent through the port, step 607. When all of the cells of the higher priority new packet have been sent through the port, the transmission the cells of the lower priority other packet are resumed, step 608.

Priority Handling Instructions 205 can be software that is stored or transmitted on any medium suitable for storing and/or transmitting digital information. As used herein, the term “channel” includes a telecommunications channel (e.g., over which Priority Handling Instructions 205 are sent for download); a Compact Disk Read Only Memory (CD-ROM); a floppy disk; flash memory, such as the Memory Stick manufactured by the Sony Corporation of Tokyo, Japan; a hard disk, etc.

The above description is to be construed as illustrative only and may be taken as the present preferred embodiment of the invention. Many modifications and variations should be apparent to those skilled in the art of data networking. For example the invention may be readily applied to a data network in which variable length packets constitute the data segments to be switched rather than fixed length cells.

What is claimed is:

1. A method for handling prioritized data in a network, including:
sending cells of a first packet of data having a first priority;
processing a second packet of data having a priority higher than that of the first packet;
suspending the transmission of cells of the first packet;
sending cells of the second packet; and
resuming the transmission of cells of the first packet.

2. The method of claim 1, further including:
processing cells of a third packet with a priority level higher than that of the first and the second packet;
suspending the transmission of cells of the second packet;
sending cells of the third packet; and
resuming the transmission of cells of the second packet.

3. The method of claim 1, wherein at least one of the first and second packets is a datagram.

4. The method of claim 1, wherein the cells of at least one of the first and second packets is a circuit-switched subpacket.

5. The method of claim 1, wherein at least one of the first and second packets is an Internet Protocol packet, and wherein the cells of at least one of the first and second packets are Asynchronous Transfer Mode subpackets.

6. An apparatus for reducing the delay of priority data in a packet network, comprising:
a processor; and
a memory coupled to said processor, said memory storing a first packet comprised of first cells, said first packet having a first priority, and said memory storing instructions adapted to be executed by said processor to send said first cells, and if the priority of a second packet comprised of second cells is higher than the priority of the first packet, then halting the transmission of the first cells, sending the second cells, and then resuming the transmission of the first cells.

7. The apparatus of claim 6, wherein at least one of the first and second packets is a datagram.

8. The apparatus of claim 6, wherein at least one of the first and second cells is a circuit-switched subpacket.

9. The apparatus of claim 6, wherein the first and second packets are Internet Protocol packets and the first and second cells are Asynchronous Transfer Mode subpackets.

10. A channel storing instructions adapted to be executed by a processor to handle prioritized data in a network, comprising:
sending a first packet comprised of first cells by sending the first cells;
interrupting the transmission of the first cells to send second cells that comprise a second packet that has a higher priority than the first packet; and
resuming the transmission of the first cells.

11. The channel of claim 10, wherein the instructions are further adapted to resume the transmission of the first cells after all of the second cells have been sent.

12. The channel of claim 10, wherein the first and second packet are datagrams.

13. The channel of claim 10, wherein the first and second cells are circuit-switched subpackets.

14. The channel of claim 10, wherein at least one of the first and second packets is a circuit-switched packet.

15. The channel of claim 10, wherein at least one of the first and second cells are packet-switched subpackets.

16. A system for handling prioritized data in a network, comprising:
a first switch that sends packets comprised of cells, the first switch configured to suspend the transmission of the cells of a lower priority first packet to transmit the cells of a higher priority second packet, and then resume transmission of the cells of the lower priority first packet; and
a second switch that receives packets comprised of cells, said second switch recognizing n distinct priority levels for packets, where n is an integer, said second switch including n buffers, wherein each of said n buffers stores cells of packets of a single priority.

17. The system of claim 16, wherein the first switch includes means for sending packets that are datagrams.

18. The system of claim 16, wherein the first switch includes means for sending packets that are circuit-switched.

19. The system of claim 16, wherein the first switch includes means for sending cells that are datagrams.

20. The system of claim 16, wherein the first switch includes means for sending cells that are circuit-switched.

21. The method of claim 1, further including determining the priority of at least one of the first packet and the second packet.

22. The apparatus of claim 6, wherein said instructions are further adapted to determine the priority of at least one of said first packet and said second packet.

23. The channel of claim 10, further comprising determining the priority of at least one of the first packet and the second packet.

24. A system for handling prioritized data in a network, comprising:
means for suspending the transmission of first cells of a first packet that has a first priority;
means for sending the second cells of a second packet having a second priority, wherein the second priority is higher than the first priority; and
means for resuming sending the first cells of the first packet after all of the cells of the second packet have been sent.

25. The system of claim 24, further comprising means for determining the priority of at least one of the first packet and the second packet.
